(19) United States
(12) Patent Application Publication
(10) Pub. No.: US 2019/0109932 A1
(43) Pub. Date: Apr. 11, 2019

(54) PORTABLE PHONE WITH INTEGRATED PERSONAL PROTECTION AND EMERGENCY NOTIFICATION MEANS

(71) Applicant: Samuel Higgins, Alpine, UT (US)

(72) Inventor: Samuel Higgins, Alpine, UT (US)

(21) Appl. No.: 14/720,743

(22) Filed: May 23, 2015

(51) Int. Cl. H04M 1/21; G08B 15/00; H04W 4/90; H04M 11/04; F41H 9/10

(52) U.S. Cl. CPC H04M 1/21; G08B 15/004; F41H 9/10; H04M 11/04; H04W 4/90

(57) ABSTRACT

An apparatus, method and system are disclosed operable with any mobile communication device such as mobile phone, tablet, electronic watch or any other portable device and providing a self-defense capability to a user by dispensing a liquid or fluid or gas or powder such as but not limited to pepper spray, tear gas, powder or the like at a potential attacker in response to the user depressing one or more pre-configured virtual or physical controls provided on his/her mobile communication device, having a case or enclosure which partially envelopes a canister of pepperspray or any other similar compound for personal protection. The system enables a citizen to seek police/emergency aid while moving in vehicles etc. The system enables keeping of text/audio/video/images record including location of such emergency events and generates a case summary of the emergency situation with recovery actions performed.

### CROSS-REFERENCE TO EARLIER FILED APPLICATION

This application claims priority to U.S. Provisional Patent Application No. 62/087,782 entitled “Smart Phone with Integrated Personal Protection Means,” filed Dec. 4, 2014 before the US Patent and Trademark Office (USPTO) for Samuel Higgins.

### BACKGROUND OF THE INVENTION

### Field of the Invention

This invention relates generally to the field of mobile communication device such as smart cellular phones/tablets/iwatch and personal protection devices and more particularly pertains to a personal protection system integrated into a mobile communication device housing which dispenses pepper spray or any other similar compound for immobilizing a live target and at the same time notifies emergency responders. The system also formulates recovery plan using artificial intelligence and analytics, for providing prompt aid to the user who is in emergency and generating the case report.

### Description of the Related Art

Smart phones and pepperspray canisters are well-known in the art, as are certain emergency alert systems. Victims of assault mount each year, and females in particular are particularly concerned with violent crimes, including assault and rape. According to the U.S. Census Bureau, 60% of of violent crimes in the US are committed against women, including rape, sexual assault, and robbery. Stalking is also of concern, and according to results obtained by a recent National Violence Against Women Survey, women are the primary victims of stalking.

The active lifestyles of college-aged women, and their limited financial means, often requires them to become dependent upon public transportation subjecting them to a corresponding increased risk of violent crime, or confrontation by a potential attacker.

Because the most commonly carried hand-held personal item is a cellular phone or tablet or iwatch, it would be advantageous for a cellular phone/tablet/iwatch to be provided which integrates a personal protection system, such as pepper spray, tear gas or Mace®, as well a system for alerting law enforcement or medical responders of an emergency. Pepper spray (oleoresin capsicum), which is commonly concentrated in strengths of 5-10%, is effective at ranges of 1 to 20 feet from an attacker.

Existing self-defense devices suffer from a number of drawbacks, including that they are often not usually readily retrievable by a potential attack victim. Additionally, users need to be empowered with an easy-to-operate, readily accessible device which can quickly notify emergency responders that an assault or crime is being, or about to be, committed. Furthermore, there exist no means in the art of maintaining evidentiary documents which might be material to an assault, rape or murder prosecution, including photographs, geographic location, alert siren, audio, video, and such media.

The prior art all suffers from a variety of limitations, including protecting emergency personnel at the expense of a user and requiring various sensors for rescue and protection of emergency personnel deployed at the incident site such as sensors for biometric information of the health/vital signs of first responders, heat/smoke sensors to provide alert regarding fire, vibration/motion sensors to sense a structure collapse, gas/vapor sensor to sense particularly carbon monoxide, chemical sensor to sense hazardous materials danger, etc.

Still another limitations of the prior art include needing to be set up at the site where an incident has actually occurred like fire, natural calamites like floods, earthquakes, etc, not enabling a citizen to seek the aid of police when he/she is confronted with an emergency situation like threat to his life by a criminal/terrorist, and not enabling a person while travelling to seek emergency aid of police, medical personnel or other agencies, and obligating a user to either carry or to be in close proximity to the emergency sensing device.

Other limitations of the prior art including nonenablement of a subscriber to seek assistance directly in case of emergency as the subscriber has no direct communication link with police, utility services, etc. The emergency sensing device activates a transmitter which transmits an emergency signal via a wireless communication interface to a mobile phone where an emergency call is established to a pre-defined destination. The emergency sensing device may not include sensors for an emergency situation that may be actually confronted by a citizen and may therefore fail to generate an emergency call.

Further limitations include nonsupport for recording of images and video which might serve as reliable evidence in a criminal prosecution.

There exists a need in the art for systems, methods and apparati that enable a user enables to take strategic decisions for future management and planning for emergency situations. Existing methods and devices in the prior art do not disclose effective combinations of cellular phones, personal defense systems, and emergency notification systems. It is therefore desirable that an cellular phone with an integrated pepper spray system and emergency notification system be provided which can be effectively activated in exigent situation.

### SUMMARY OF THE INVENTION

From the foregoing discussion, it should be apparent that a need exists for a smart phone with integrated personal protection means. Beneficially, such an apparatus would overcome many of the difficulties with prior art by providing a safer means of storing the pepper spray and more efficient means of activating the pepperspray by a potential victim.

The present invention has been developed in response to the present state of the art, and in particular. Accordingly, the present invention has been developed to provide a smart phone having personal protection and emergency notification means, the system comprising: a smart phone; a housing partially enveloping the smart phone, the housing defining an internal recess for receiving a detachable pressurized canister of pepper spray, the housing comprising a physical button, a interface module, a dispenser module and a electromechanical means for activating the canister such that the pepper spray from the canister is emitted outward into ambient air when a user depresses physical button present on the housing or when a user depresses one or more pre-configured physical/virtual button of the smart phone.

The smart phone of claim 1, further comprising a computer program/mobile application software product in nontransitory computer-readable memory, for configuring physical button of the housing, for configuring physical/virtual button of the smart phone and external triggers, for controlling the dispenser module of the housing and displaying one or more virtual buttons/controls on the smart phone, wherein activation of said physical/virtual controls: dispenses pepper spray from the canister; begins recordation of images, video and audio on the phone; transmits an emergency message comprising of alert siren, images, videos, audio and geographic location of the smart phone to a central server/cloud in logical communication with DPDs of a law enforcement agency and other emergency responders over a wide area network (WAN)/Internet or directly to DPDs of a law enforcement agency and other emergency responders by using PSTN network and services such as but not limited to Phone call, SMS.

The computer program/mobile application software product of claim 2, also capable to receive the emergency messages comprising of alert siren, images, videos, audio and geographic location via a central server/cloud or directly via a PSTN Network and services such as but not limited to GPRS, email, phone call, VOIP, IVR call, SMS.

The canister may be disposed in parallel orientation to any of the edge of the smart phone. The canister may be wholly enveloped by the housing such that a presence of the canister in the housing is imperceptible visually.

A system having personal protection means and emergency alert functionality is also provided, the system comprising: a smart phone; a housing/war head unit with a detachable pressurized canister of pepper spray, interface module and dispenser module, the housing/war head unit interact with the smart phone via interface module, the canister comprising a nozzle electronically activatable by the smart phone or by the smart phone housing/war head unit button; a dispenser module configured to open the nozzle and dispense pepper spray in response to physical button present on the housing/war head unit or in response to one or more pre-configured physical/virtual controls on the smart phone being activated; a computer/mobile software product with various modules, a configure and control module that configures the smart phone with the interface module and dispenser module of housing/war head unit and also configure the smart phone physical/virtual controls and external devices to use as a triggers, a configure and control module also controls the dispenser module of housing/war head unit which further electronically activate the nozzle and dispense pepper spray in response to physical/virtual controls of the smart phone or external trigger being activated; a console module configured to display a list of message sent to law enforcement/emergency responders, list of messages received from law enforcement/emergency responders and also enables the user for providing input; a interpreter module configured to determine which of a physical/virtual controls have been used as a trigger by a user to activate the system and keep listening for a trigger activation; a message formatter module configured to encrypt and decrypt messages sent/received to and from law enforcement/emergency responders; and a transmitter/receiver module configured to transmit an encrypted emergency message to law enforcement/emergency responders comprising media recorded automatically on the smart phone with location coordinates in response to physical/virtual controls being activated by the user. Transmitter/receiver module also configure to receive the emergency message from the law enforcement/emergency responders.

The smart phone may be provided with at least one user configured customized physical/virtual controls or the smart phone may also configured with some external trigger such as but not limited to bracelet, watch etc which is selectable by a user in an emergency for the purposes of signaling to one or more emergency responders that a crime is in progress.

The smart phone housing/war head unit may also be provided with a physical button which is selectable by a user in an emergency for the purposes of signaling to one or more emergency responders that a crime is in progress.

In some embodiments, the transmitter receiver module may be configured to transmit the emergency message by SMS using PSTN infrastructure.

In some embodiments, the smart phone housing/war head unit may further comprise of interface module for integrating/connecting/communicating with any mobile communication device such as but not limited to mobile phone, iPad, iPhone, iwatch, Tablet, electronic watch or any other such portable device via USB/Bluetooth/wifi/RFID/Radio, Charging socket, earphone socket or plurality of such technology but not limited to or by any other port or socket or technology available in mobile communication device. The smart phone housing/war head unit may further comprise of dispenser module and electromechanical means for activating the canister by opening the nozzle such that the pepper spray from the canister is emitted outward into ambient air. The smart phone housing/war head unit may further comprise of GPS chip that enables the Non-GPS smart phone with GPS functionality.

In some embodiments, in place of housing, the smart phone having integrated personal protection means may comprises of a “War Head” unit which can be either attached, affixed, slide upon, or latched onto a Mobile Communication Device/smart phone and dispenses pepper spray just like housing in response to physical button present on the “War Head” or in response to one or more pre-configured physical/virtual controls on the smart phone or some external trigger being activated.

“War Head” unit can be connected, configured with any said user mobile communication device such as mobile phone, iPad, iPhone, Tablet, electronic watch or any other such portable device via USB, ear phone socket, power socket, RFID/wifi/Bluetooth/radio or plurality of such technology but not limited to or by any other port or socket or technology available in mobile communication device. “War Head” unit can be connected/disconnected, slide on or slide off, attached or removed with said user communication device at any time without any need to restart or power down the said coupled communication device or “War Head” unit itself.

“War Head” unit is capable to be attached with any mobile communication device and having plurality of different functions but not limited to such as spitting/spraying liquid/fluid/gas/powder to a human or any other animal or living being merely by selectively pressing/clicking/touching of user configured customized button/buttons/touch sensitive key/keys/software icon provided on his/her mobile communication device such as mobile phone, iPad, iPhone, Tablet, electronic watch etc. or by pressing/selecting the button provided on the “War Head” or by activating some pre-configured external trigger such as button present on bracelet/watch and the like.

“War Head” unit also provides a self-defense and emergency notification capability to a user with the help of proprietary mobile software application and by using of existing available features/components/resources of user's mobile communication device and can be used as a variant of housing.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper elevational perspective view of a housing which is a integrated personal protection means in accordance with the present invention;

FIG. 1B is an upper elevational perspective view of a housing which is a integrated personal protection means in accordance with the present invention;

FIG. 1C is an upper elevational perspective view of a housing which is a integrated personal protection means in accordance with the present invention;

FIG. 1D is an upper elevational perspective view of a war head unit which is another variant of integrated personal protection means in accordance with the present invention;

FIG. 1E is an side elevational perspective view of a smart watch having housing as a integrated personal protection means in accordance with the present invention;

FIG. 2A is a lower elevational perspective view of a housing which is a integrated personal protection means in accordance with the present invention;

FIG. 2B is a lower elevational perspective view of a housing which is a integrated personal protection means in accordance with the present invention;

FIG. 2C is a lower elevational perspective view of a housing which is a integrated personal protection means in accordance with the present invention;

FIG. 2D is a upper elevational perspective view of a smart phone having war head unit as a integrated personal protection means in accordance with the present invention;

FIG. 2E is a upper elevational perspective view of a smart watch having housing as a integrated personal protection means in accordance with the present invention;

FIG. 3A is a upper elevational perspective view of a mobile communication device with a touch screen having housing as a integrated personal protection means in accordance with the present invention;

FIG. 3B is a upper elevational perspective view of a mobile communication device with a mobile button having housing as a integrated personal protection means in accordance with the present invention;

FIG. 3C is a upper elevational perspective view of a mobile communication device having housing with a housing button as a integrated personal protection means in accordance with the present invention;

FIG. 3D is a upper elevational perspective view of a mobile communication device with external trigger having housing as a integrated personal protection means in accordance with the present invention;

FIG. 3E is a upper elevational perspective view of a smart watch with visual control having housing as a integrated personal protection means in accordance with the present invention;

FIG. 4A is an environmental perspective of a cellular phone having housing as a integrated personal protection means in accordance with the present invention;

FIG. 4B is an environmental perspective of a cellular phone having war head unit as a integrated personal protection means in accordance with the present invention;

FIG. 4C is an environmental perspective of a cellular phone having housing and cellular phone having war head unit as a integrated personal protection means in accordance with the present invention;

FIG. 4D is an environmental perspective of a smart watch with a integrated personal protection means in accordance with the present invention;

FIG. 5 a flowchart of method for integrating and activating personal protection and emergency notification means with a smart phone in accordance with the present invention;

FIG. 6 is a block diagram of a system having portable phone with integrating personal protection and emergency notification functionality in accordance with the present invention;

FIG. 7 is an entity-relationship diagram illustrating the relationship and flow of information between different entities involving in activated integrated personal protection system in accordance with the present invention; and

FIG. 8 is an entity-relationship diagram illustrated the data interchange between entities via Internet and cloud/server environment by using smart phone with a integrating personal protection and emergency notification means in accordance with the present invention;

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is the object of the present invention to provide a smart security and emergency aid system and personal defense functionality and method of operating thereof wherein the system enables a user to seek help of family member, law enforcement and/or medical personnel in an emergency, such as a crime, riot, terrorist attack, etc., or in medical emergencies or natural calamities like floods, earthquake, etc., as well as other emergencies event by selectively pushing button present on the mobile communication device housing/war head unit or by pressing/clicking one or more combination of user configured customized virtual/physical controls or phone buttons, or touch sensitive keys provided on a mobile communication device such as mobile phone, Tablet, iPad, iPhone, iwatch and the like.

It is further an object of the present invention is to provide an integrated personal protection system which can be connected, configured and operable with any communication device such as mobile phone, iPad, iPhone, Tablet, iwatch or any other portable device and providing a self-defense capability to a user by spitting/spraying or dispenses pepper spray, tear gas, powder or the like at a potential attacker in response to the user depressing one or more virtual or physical controls of his/her mobile communication device or when a user selectively pushing button present on the mobile communication device housing/war head unit or when a user activate some external trigger which is configured to activate the system, which further immobilize a potential attacker or live target.

It is yet another object of the present invention is to provide a system which enables a user who is a victim/witness of a crime, emergency or natural disaster to record evidence of that event encountered by a user in text, audio, image or video format. It is further an object of the present invention is to provide a system which provides a “recovery plan” after analysis of the emergency event information using artificial intelligence and analytics thereby enabling authorities to provide prompt emergency aid to a victim.

Still a further object of the present invention is to provide a system which enables a cellular phone or any other mobile communication device to provide “live streaming”/recorded streaming of the emergency incident from the user to emergency responders such as police. It also an object of the present invention is to provide a system which enables a user/victim to provide his/her geographic location to the emergency responders in case of emergency. The location of the citizen is identified with the help of the system and a cursor displayed on a map for emergency responders, as well as to provide a system which enables an emergency responder to ascertain a direction of travel and rate of speed of a user. Systems and apparati serving these objects may include hardware/device like a watch, pen, locket, belt, etc. that are made or configured according to the system and can be used as am external trigger to invoke the Mobile Application Software installed on the user communication device which further activate the system in case of emergency when a user (or victim) is unable or find and press the user configured customized button present on his/her mobile communication device.

Even further object of the present invention is to provide a system which is intelligent to automatically route and forward the emergency message to the nearest police or servicemen or emergency responder and escalate the message to next higher authority or to any other responder if there is any delay in response. Still it is a further object of the present invention is to provide a system which works when there is low network signal strength and when the data connection as such is not available on mobile communication device. In these situations the emergency message may be transmitted via SMS (short message service) or via secondary medium such as bluetooth, wifi etc to the emergency responders/law enforcement and other agencies. And the complete message is recorded/buffered in the mobile device and later sent automatically when there is improved signal strength available.

It even further an object of the present invention is to provide a system which enables the user to send the emergency message also to the preconfigured numbers, a system that automatically creates a case diary of emergency situation encountered by the citizen/victim, wherein the case diary is the summary of the emergency event which gets used in planning recovery steps and also acts as a reference in future investigation.

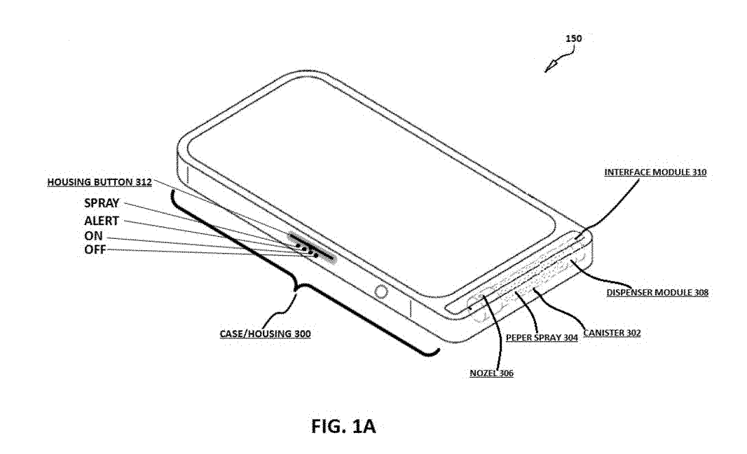

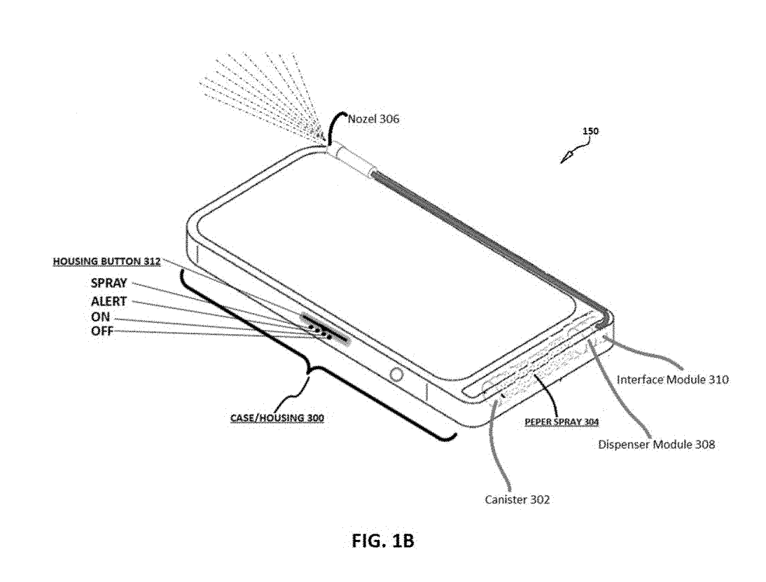

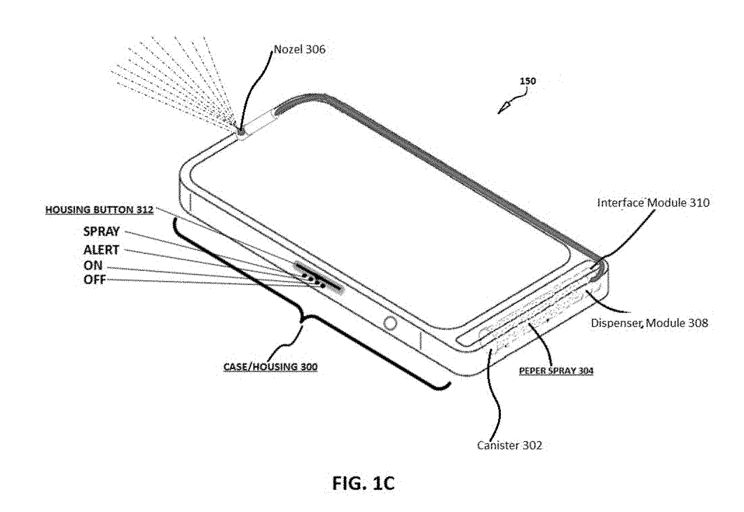

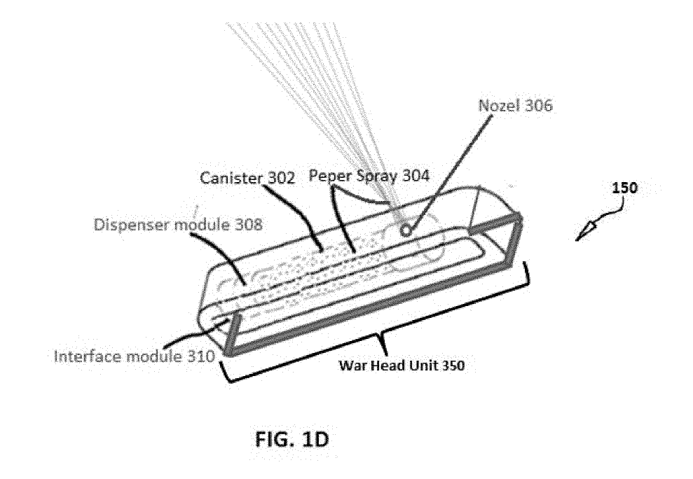

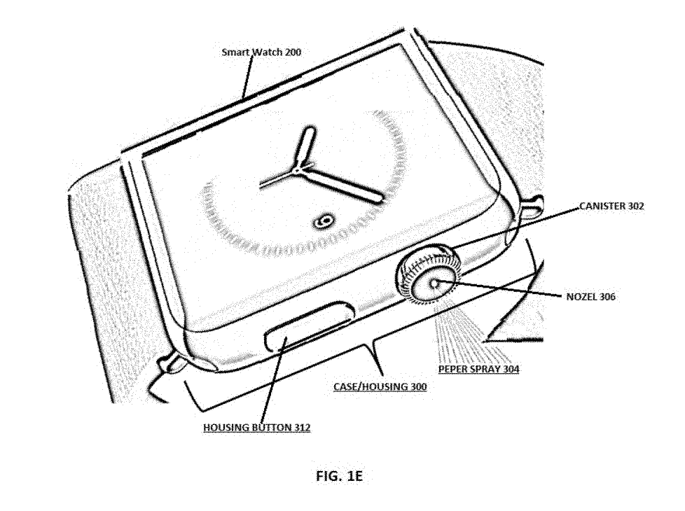

FIG. 1A is an upper elevational perspective view of a housing 300 which is a integrated personal protection means 150 in accordance with the present invention. The housing 300 comprises of a canister 302 containing a pepper spray 304, a nozzle 306, a dispenser module 308, a interface module 310 and a housing button 312.

In various embodiments, the canister 302 comprises pepper spray. In other embodiments, the canister comprises another noxious or poisonous gas such as tear gas. The canister 302, in the shown embodiment, is not activated (sprayed) by manual depression of pressure release valve on the canister, rather the canister is activated by housing button 312 or by user interface (mobile button 204, virtual controls 206) of the smart phone 200 via software, firm ware or the like. The housing button 312 may have plurality of different function such as but not limited to off, on, alert and spray function.

FIG. 1B is a upper elevational perspective view of a housing 300 which is a integrated personal protection means 150 in accordance with the present invention. In this variant of housing 300, canister 302 containing a pepper spray 304, a dispenser module 308, a interface module 310 is fitted at lower edge of the housing 300 and a nozzle 306 on the side edge of the housing 300.

FIG. 1C is also a upper elevational perspective view of a housing 300 which is a integrated personal protection means 150 in accordance with the present invention. In this variant of housing 300, canister 302 containing a pepper spray 304, a dispenser module 308, a interface module 310 is fitted at the lower edge of the housing 300 and a nozzle 306 on the top edge of the housing 300.

In other embodiments, different variant of housing 300 with non-limiting examples may comprises of some more or less components without any limitations and all these components including, canister 302 containing a pepper spray 304, a nozzle 306, a dispenser module 308, a interface module 310, button 312 may fit or place, individually or collectively, inside or outside, on any of the edge or side of the housing 300 without any limitations.

FIG. 1D is an upper elevational perspective view of a war head unit 350 which is another variant of integrated personal protection means 150 in accordance with the present invention; The war head unit 350 can be attached, clipped, affixed, slide upon, or latched onto a smart phone 200 and comprises of a canister 302 containing a pepper spray 304, a nozzle 306, a dispenser module 308, a interface module 310 and a button 312.

In various embodiments, the working of the war head unit 350 is same as of the housing 300 and the canister of the war head unit 350 also contains pepper spray or another noxious or poisonous gas such as tear gas. The canister 302 of the war head unit 350, in the shown embodiment, is not activated (sprayed) by manual depression of pressure release valve on the canister, rather the canister is activated by war head unit button 312 or by user interface (mobile button 204, virtual controls 206) of the smart phone 200 via software, firm ware or the like. The button 312 of the war head unit 350 may have plurality of different function such as but not limited to off, on, alert and spray function.

In other embodiments, different variant of war head unit 350 with non-limiting examples may comprises of some more or less components without any limitations and all these components including, canister 302 containing a pepper spray 304, a nozzle 306, a dispenser module 308, a interface module 310, button 312 may fit or place, individually or collectively, inside or outside, on any of the edge or side of the war head unit 350 without any limitations.

The housing 300/war head unit 350 may comprise digital, mechanical, electromechanical, or electrical components necessary to open a pressure release valve on the canister 302 and spray the canister's contents 304 at a would be attacker or live target 901 by pointing a nozzle 306 at the attacker 901.

The components forming the housing/war head unit may be in logical communication with the smart phone 200 via means known to those of skill in the art, including via stand electrical ports and/or via a bus interconnecting the components with a one or more microprocessor(s) or via USB/Bluetooth/wifi/RFID/Radio, Charging socket, earphone socket or plurality of such technology but not limited to or by any other port or socket or technology.

In various shown embodiments, the canister 302 is completely enclosed by the housing 300/war head unit 350. The canister 300 may be insertable or detachable with the housing 300/war head unit 350. In various embodiments, the canister 302 is disposable.

FIG. 1E is an upper elevational perspective view of a smart watch 200 having integrated personal protection means 150 in accordance with the present invention; The smart watch 200 comprise of a touch screen 202, a depressible button 204, virtual controls 206, communication interface 208 and the housing 300.

The smart watch 200 may be configured to activate the canister 302 upon single/multiple/repeated depressions of the button 312 or by user interface (button 204, virtual controls 206) of the watch 200 via software, firm ware or the like. In some embodiments, the smart watch 200 is configured to activate the canister 108 upon three or four rapid (user configurable), successive depression of the button 204.

The canister may be wholly enveloped, or enclosed, by the smart watch housing such that the presence of the canister is imperceptible visually to a would be attacker.

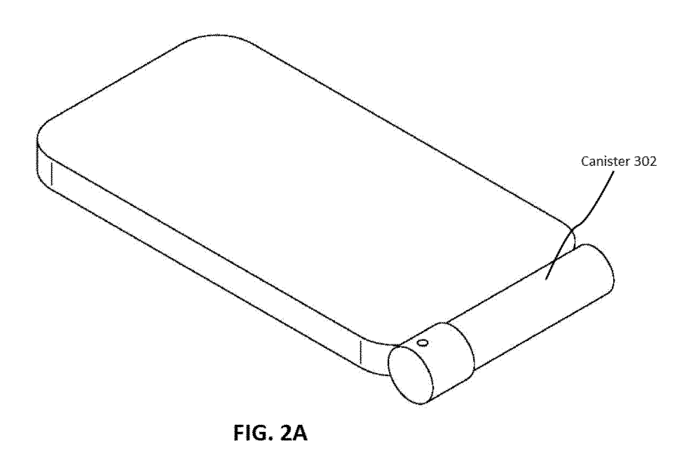

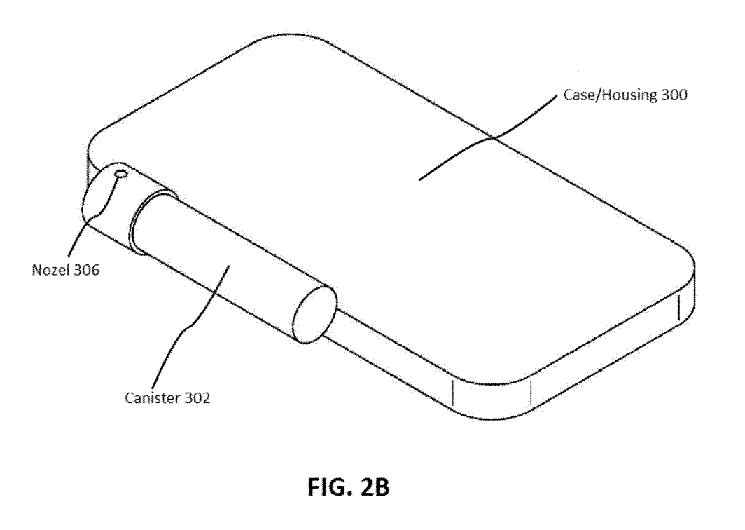

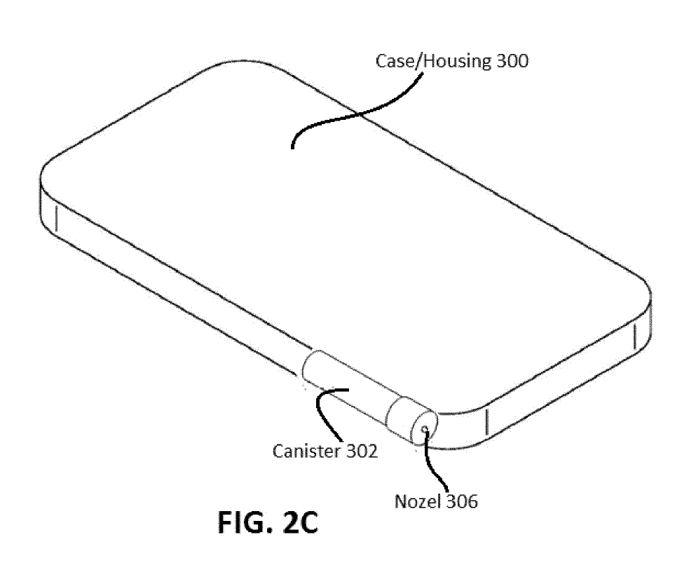

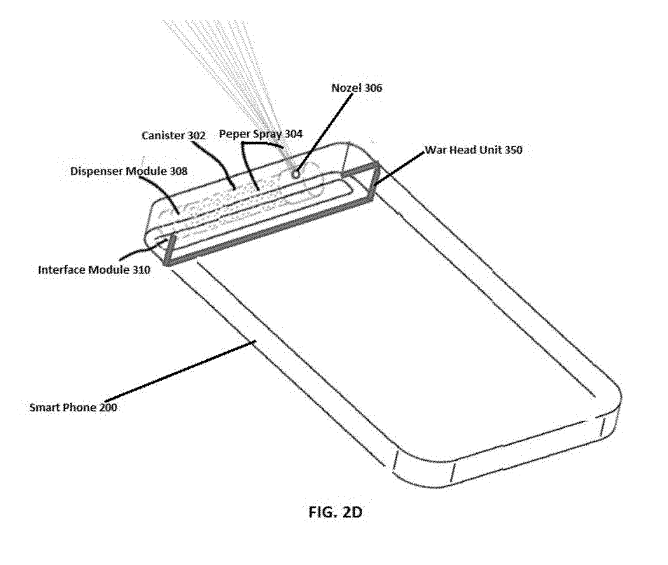

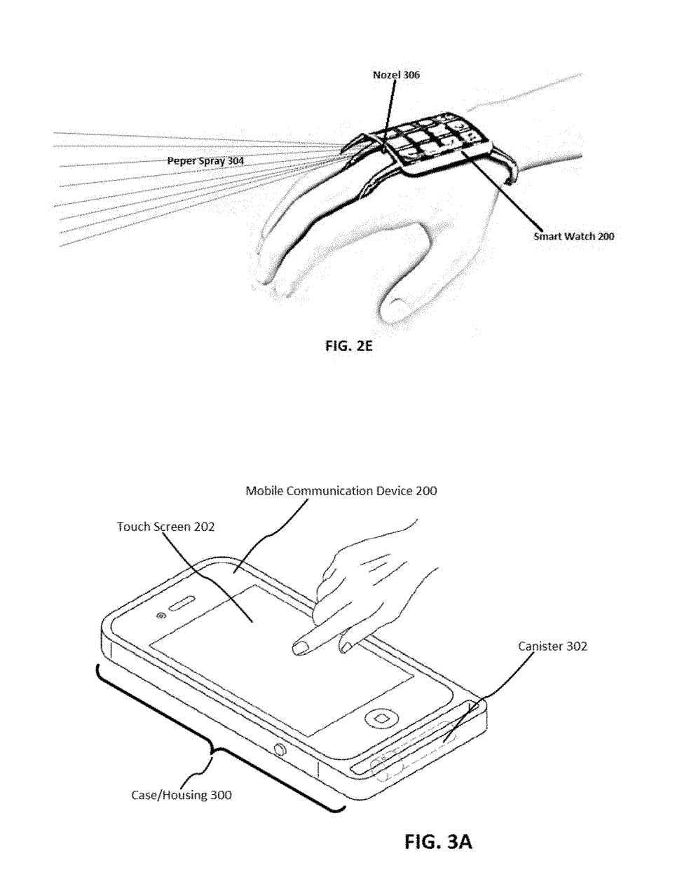

FIG. 2A is a lower elevational perspective view of a cellular phone 200 having integrated personal protection means 150 in accordance with the present invention. In the shown embodiments, the canister 302 is outside of the housing 300. The canister 302 is detachably affixed to the housing using means known to those of skill in the art.

The back of the housing 302 is shown face up. The shown phone 200 comprises not just means for dispensing pepper spray, but also the software application 400 installed in computer readable memory further described above and below.

FIG. 2B is a lower elevational perspective view of a cellular phone 200 having integrated personal protection means 150 in accordance with the present invention.

As shown, the canister 302 may be affixed laterally to the housing 300. The canister may alternatively be affixed at the option of the user to either the top, side and/or bottom of the housing 300.

FIG. 2C is a lower elevational perspective view of a cellular phone 200 having integrated personal protection means 150 in accordance with the present invention.

As shown, the nozzle 306 of canister 302 may be affixed either the top, side and/or bottom of the canister 302.

FIG. 2D is a lower elevational perspective view of a cellular phone 200 having war head unit 350 as a integrated personal protection means 150 in accordance with the present invention.

As shown, the war head unit 350 may be latched on to the cellular phone 200. The war head unit 350 may alternatively be latched at the option of the user to either the top, side and/or bottom of the cellular phone 200.

FIG. 2E is a upper elevational perspective view of a smart watch 200 having war head unit 350 as a integrated personal protection means 150 in accordance with the present invention.

As shown, the war head unit 350 may be latched on to the smart watch 200. The war head unit 350 may alternatively be latched at the option of the user to either the top, side and/or bottom of the smart watch 200.

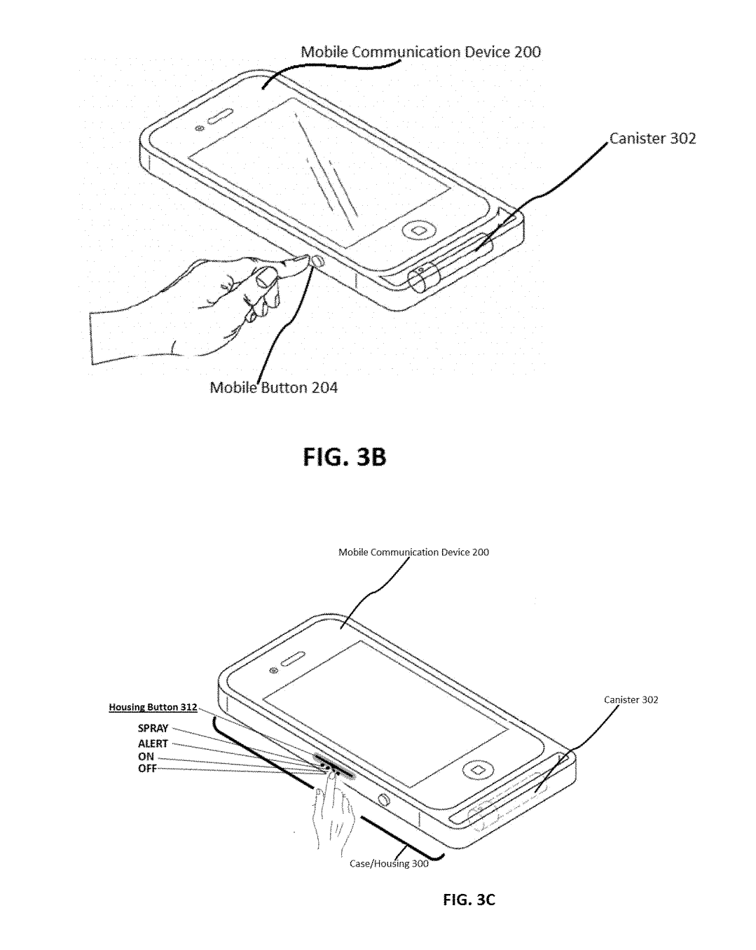

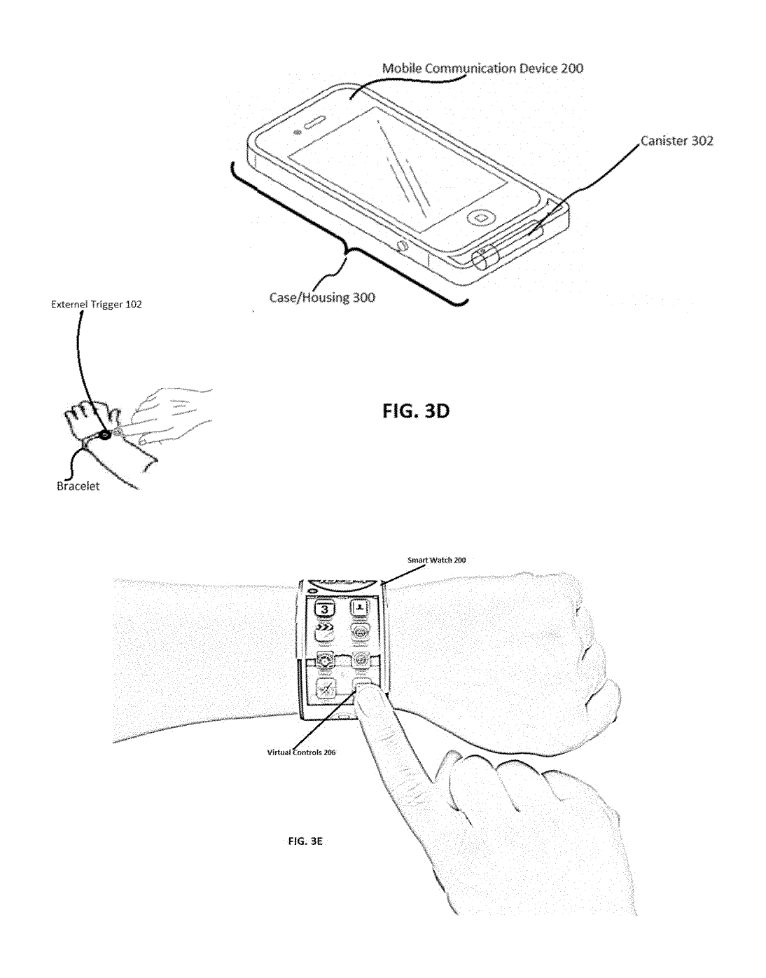

FIG. 3A is a upper elevational perspective view of a smart phone 200 having integrated personal protection means 150 in accordance with the present invention.

As shown, the system may be activated by the virtual controls 206 displayed on a touch screen 202 of the smart phone 200.

FIG. 3B is a upper elevational perspective view of a smart phone 200 having integrated personal protection means 150 in accordance with the present invention.

As shown, the system may be activated by the smart phone's pre-configured physical button 204 such as but not limited to power button, volume button or any other button of the smart phone 200.

FIG. 3C is a upper elevational perspective view of a smart phone 200 having integrated personal protection means 150 in accordance with the present invention.

As shown, the system may be activated by the button 312 presented on a housing 300 of the smart phone 200.

FIG. 3D is a upper elevational perspective view of a smart phone 200 having integrated personal protection means 150 in accordance with the present invention.

As shown, the system may be activated by some external trigger 102 such as but not limited to the button or trigger given on bracelet, pen, watch etc which is configured with the smart phone 200.

FIG. 3E is a upper elevational perspective view of a smart watch 200 having integrated personal protection means 150 in accordance with the present invention.

As shown, the system may be activated by the virtual controls 206 of the smart watch. In various embodiments, the system may also be activated by the smart watch button 204 or by the button 312 presented on a housing 300 of the smart watch 200.

In various above and below embodiments, the mobile communication device 200 may be configured by mobile software application 400 to allow a user 900 to select a physical/virtual button or other control displayed on the touch screen 202 to be use as a internal trigger 101 and external trigger 102. In various embodiments, the user may open an application on the mobile communication device touch screen 202 which in turn may activate the canister 302.

The mobile communication device 200 may be configured to activate the canister 302 upon single/multiple/repeated depressions of the button 204. In some embodiments, the mobile communication device 200 is configured to activate the canister 302 upon three or four rapid (user configurable), successive depression of the button 204.

The canister may be wholly enveloped, or enclosed, by the housing such that the presence of the canister is imperceptible visually to a would be attacker.

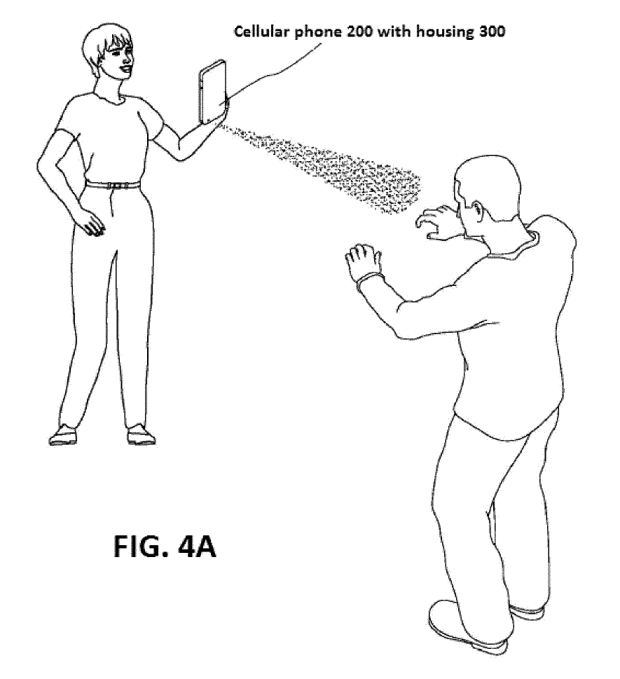

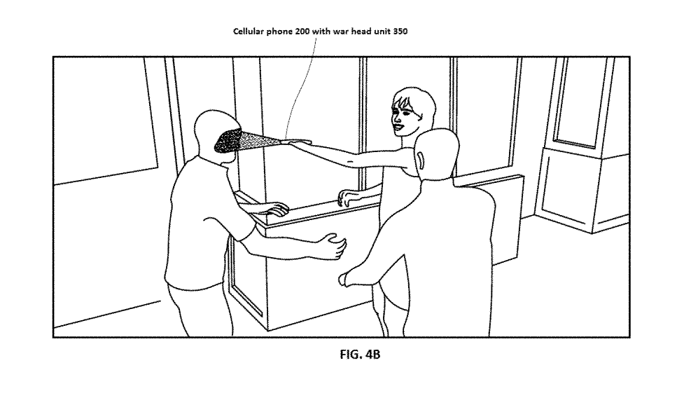

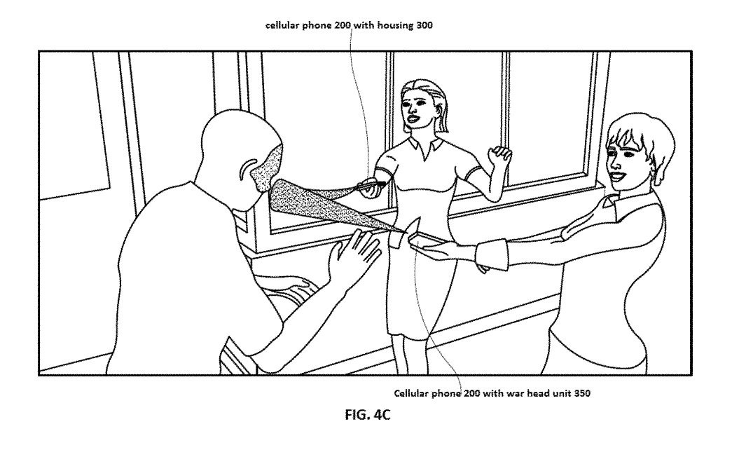

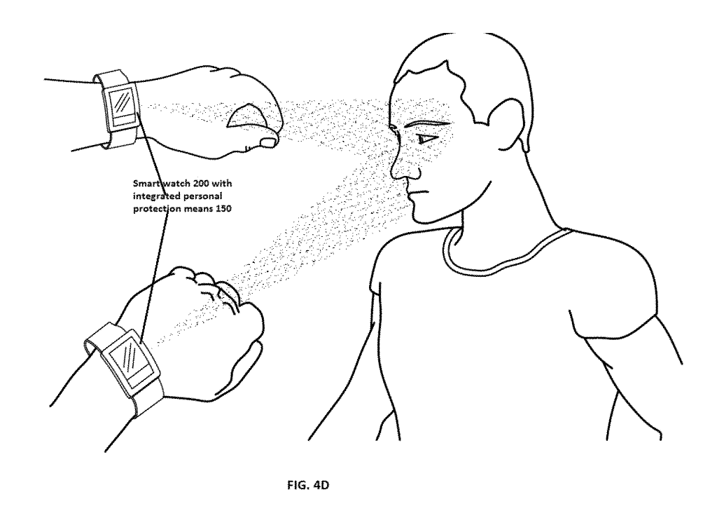

FIG. 4A, FIG. 4B, FIG. 4C is an environmental perspective view of a cellular phone having integrated personal protection means and FIG. 4D is an environmental perspective view of a smart watch having integrated personal protection means in accordance with the present invention.

A user configured customized button/touch sensitive key or virtual control on the phone/smart watch 200 may be depressed to both dispense fluid or gas 304 stored in the canister 302 outward into ambient air and also to alternatively or additionally notify law enforcement of an emergency and begin recording media using inputs on the phone/smart watch 200.

The transmission of messages either in the text or audio or video or image is commenced via internet/data connection/GPRS to a central server/cloud 700 and onward into the database and displayed on the monitoring system/mobile communication devices/computers connected to the central server/cloud 700 when the user 900 depresses physical button 312 of the housing 300/war head unit 350 or depresses physical/virtual button of the mobile communication device 200 or when external trigger 102 is being activated by the user 900. In this embodiment, a server application software 800 is installed on central server/cloud 700.

In the embodiment shown, when user configured customized button/touch sensitive key is pressed/clicked by the citizen who is in medical emergency or is a victim of fire incident or natural calamities, the mobile communication device 200 is in communication with the central server/cloud 700 via wireless telecommunication networks. As shown, the mobile communication device 200 with a integrated personal protection means 300/350 may be used to spray on a potential attacker. The nozzle 306 of the canister 302 may be designed and configured to spray outward away from the housing 300/war head unit 350. Alternatively, the nozzle may be configured to laterally.

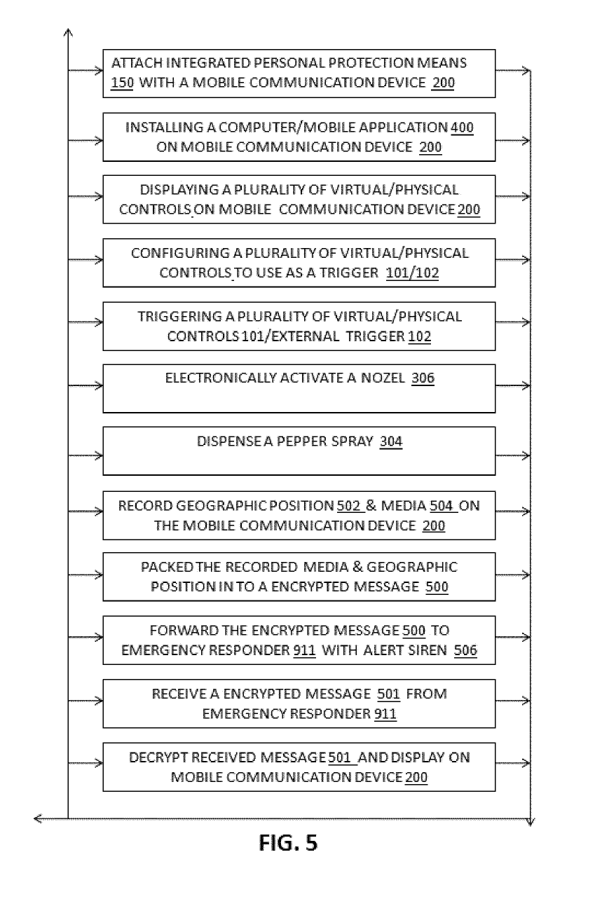

FIG. 5 is a flow chart of the steps of a method for integrating and activating a personal protection system with a portable phone in accordance with the present invention. The method proceeds as shown and substantially described herein above and below.

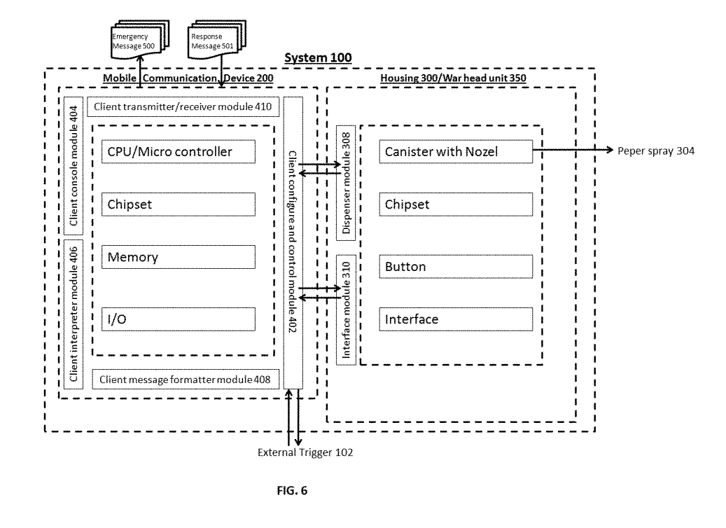

FIG. 6 is a block diagram of a system 100 having mobile communication device with integrating personal protection and emergency notification functionality in accordance with the present invention;

In the shown embodiment, the system 100 comprises a mobile software application 400 with its various modules installed on a mobile communication device 200 which is coupled with integrating personal protection means 150 (housing 300/war head unit 350) comprises of electro-mechanical components with various modules.

A mobile software application 400 is installed on user's 900 mobile communication device 200. The mobile software application 400, without implying any limitation, comprises a client configure and control module 402, a client console module 404, a client interpreter module 406, a client message formatter module 408, and a client transmitter/receiver module 410.

A client configure and control module 402 configure the mobile communication device 200 with the housing 300/war head unit 350. A client configure and control module 402 also configure the smart phone physical/virtual controls and external devices to use as a triggers to activate the system 100. A client configure and control module 402 controls a housing 300/war head unit 350 via interface module 310 and a dispenser module 308 and electronically activate the nozzle 306 of the canister 302 and dispense pepper spray 304 in response to physical/virtual controls of the smart phone or external trigger 102 being activated by the user 900;

The client console module 404 of the mobile software application 400 displays the Graphical User Interface (G.U.I.) with various user and system settings related icons and the list of emergency messages and emergency responses send/received to and from the emergency responders 911. Client console module 404 also take input from the user 900. Client console module 404 displays configured and selected pre-configured buttons/touch sensitive keys or external devices on the user's 900 mobile communication device 200 which can be used as a trigger.

The client interpreter module 406 determine and interprets the button/touch sensitive key/external trigger being pressed/clicked or activated by the user 900.

The client message formatter module 408 creates an emergency message 500 in either of the text, audio, video, image or in any combination or formats without any limitations and also encrypt/decrypt emergency message 500 sent to or emergency response message 501 received from emergency responders 911.

The client transmitter/receiver module 410 transmit an encrypted emergency message 500 to emergency responders/law enforcement 911 comprising alert siren 506, geo-location 502 of the phone and media 504 recorded automatically on the smart phone 200 in response to pre-configured physical/virtual controls/trigger being activated by the user 900. Client transmitter/receiver module 410 also receives the emergency response message 501 from the emergency responders/law enforcement 911.

In the shown embodiment, the interface module 310 of personal protection means 150 (housing 300/war head unit 350) provides an interface for connecting the housing 300/war head unit 350 with a mobile communication device 200.

The dispenser module 308 of personal protection means 150 (housing 300/war head unit 350) controls the nozzle 306 of canister 302 and other electro-mechanical components of the housing 300/war head unit 350. Dispenser module 308 electronically activate the nozzle 306 and dispense pepper spray 304.

In some embodiments, the mobile software application 400 is installed at the user's mobile communication device 200 is in communication with external devices/triggers.

In other embodiments, the mobile software application 400 is installed at the user's mobile communication device 200 is in communication with server application software 800 installed on central server/cloud 700 which further is in communication with the mobile communication devices/computers 200 of police/law enforcement and other emergency responders 911. In some other embodiments, the mobile software application 400 installed at the user's mobile communication device 200 is also able to communicate directly with the mobile communication devices/computers 200 of police/law enforcement and other emergency responders 911 using SMS and other PSTN/technologies/infrastructure without any limitations.

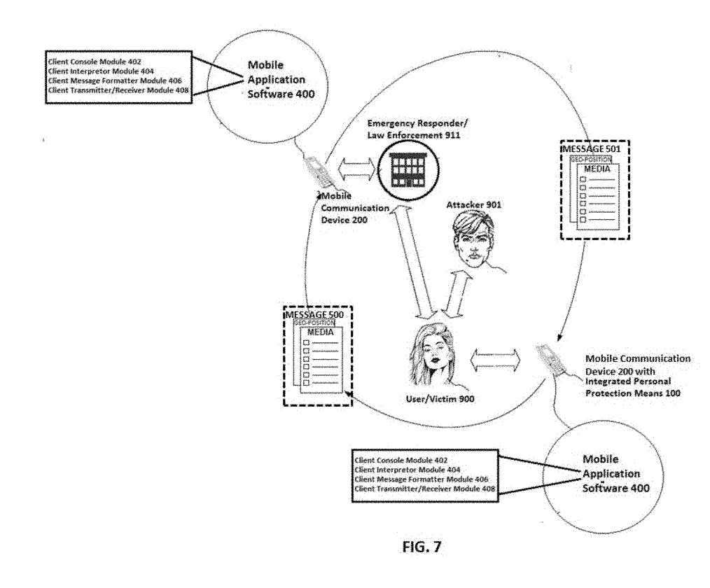

FIG. 7 in an entity-relationship diagram illustrating the relationship and flow of information between different entities involving in activated portable phone with integrated personal protection and emergency notification system 100 in accordance with the present invention.

The user 900 (also a victim) is, in the preferred embodiment, an individual, may be any legal entity engaged in commercial or nonprofit activity. For the purposes of the present specification, the terms “customer” and “guest” are used interchangeably. In the shown embodiment, User/Victim 900 activate the system 100 which immediately dispenses the pepper spray 304 on the attacker 901 and transmit emergency message 500 (including alert bell 506, geographic location 502, media 504) from the user's/victim 900 smart phone 200 to the mobile communication device 200 of emergency responders/law enforcement agency 911.

In the shown embodiment, User/Victim 900 also receives the response message 501 from the emergency responder or law enforcement agency 911

In various embodiments, the user 900 installs a mobile software application 400 on a smart phone 200 under the control of the user 900 which enables the phone 200 to be used in storing, recording and transmitting of alert siren 506, geo location 502 and media 504. This mobile software application 400 comprises a software program product with automatically updates and reconfigures the smart phone 200 to authenticate or disauthenticate the guest and/or customer 908.

The emergency responder or law enforcement agency 911 may include a police department, fire department, switchboard operator and the like. In other embodiments, the emergency message 500 is also relayed to emergency medical responders, such as doctors, medical personnel, hospitals, ambulances, and the like. In still further embodiments, the emergency message 500 may be relayed to friends/family members 904 or to one or more personal contacts stored on the user's 900 smart phone 200. In other embodiments, the emergency message 500 may also relayed to the nearest anonymous responders 902 or to the social media 906.

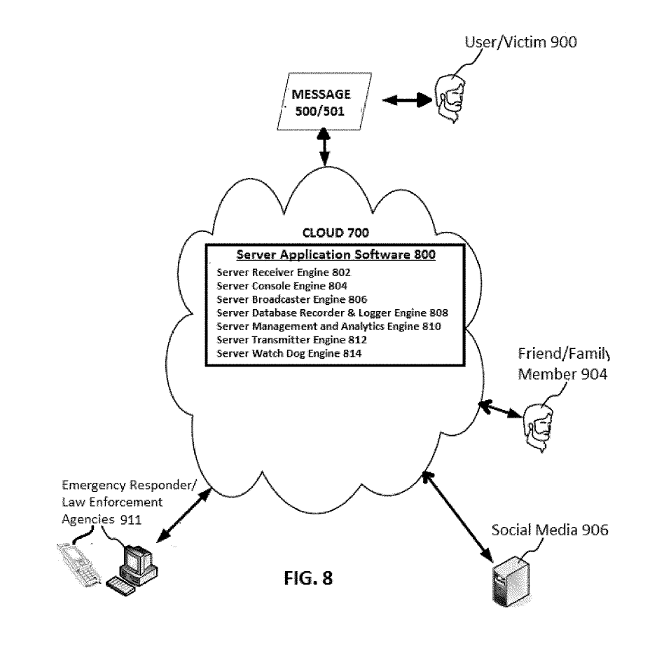

FIG. 8 is an entity-relationship diagram illustrated the data interchange between entities material to a system 100 for integrating personal protection and emergency notification with a smart phone in accordance with the present invention.

The system 100 in the shown embodiment comprises a user 900, a emergency message 500, an Internet 602, a cloud 700, a server application software 800, a response message 501, a law enforcement 911, a friend/family member 904, a social media 906. Each of these is substantially described above and below.

As shown, the emergency message 500 may be relayed to a emergency responder such as friend 704, family member, employer, or the like.

The system further comprises a central server/cloud 700 and the server application software 800 with its various engines installed on a cloud 700 substantially described above and below. A central server/cloud 700 is under the control of law enforcement or a third-party agency which automatically transmits the emergency message 500 and emergency response message 501 bi-directionally between the user 900 and emergency responder using artificial intelligence and analytics without requiring any operator. The central server/cloud 700 with the server application software 800 facilitates communication across a network between users 900 and law enforcement/emergency responders 911/anonymous responders 902/friends/family members 904/social media 906.

In the shown embodiment, server application software 800 which without implying any limitation comprise server receiver engine 802; Server Console engine 804; server broadcaster engine 806; server database recorder and logger engine 808; server management and analytics engine 810; server transmitter engine 812 and server watch dog engine 814. These engines execute the necessary course of action for reported emergencies.

The server receiver engine 802 receives the emergency message 500 comprises the geographic location 502 and media 504. This emergency message 500 is processed in the server receiver engine 802 and then sent to the Server Console engine 804. The server receiver engine of the server application software, which without implying any limitation, comprises server receiver module, server message decoder module and server authentication module. The function of server receiver module is to receive emergency message and send the emergency message to server message decoder module, which decodes it and authenticates it with the help of server authentication module. The server authentication module verifies that the received emergency message is from authorized source and is not corrupted by using different algorithms. After successful authentication, server receiver engine records emergency message to database using Server Database Recorder and logger Engine and gives processed emergency message to Server Console engine.

The Sever Console engine 804 then processes the emergency message received from server receiver engine, displays the emergency message on to the mobile communication devices/computers of emergency responders 911 and may also sends thus processed message to server broadcaster engine 806. The Sever Console engine 804 may also configure to takes the input from the emergency responders. The server console engine 804 of the server application software 800, without implying any limitation, comprises the server console receiver module and server console display module. The server console receiver module receives emergency message from receiver engine and pass it to server console display module. The server console display module display the received processed emergency message from server console receiver module on to the mobile communication devices/computers of police/emergency responders. The server console display module enables managing of the user interface for the console of mobile communication device/computers of emergency responders. The user attending the console of mobile communication device/computers of emergency responders gives proper inputs over the displayed emergency message in given time frame. If the given time frame expires then the emergency message is treated as an unattended emergency message and the emergency message gets forwarded to server broadcaster engine 806 automatically. Upon receiving inputs from the responder operating the console of mobile communication device/computer of police/emergency responder 911, the server console engine processes the input emergency message and then sends it to the server broadcaster engine 806.

The server broadcaster engine 806 of the server application software 800, without implying any limitation, comprises server broadcaster message analyzer module. The server broadcaster message analyzer module receives emergency message from server console engine and analyze the emergency message and check if emergency message requires further broadcasting or not. If further broadcasting is required then server broadcaster message analyzer module forwards it to transmitter engine which then transmits the emergency message to the identified emergency responder 911 or to the selected friends/family member 904 or to anonymous responder 902, group of users, or to all users on their mobile communication device and as well as to social media 906, web and other channels prior to, during, and after an emergency incident occurs. The server broadcaster engine is also connected to server management and analytics engine 810.

Server management and analytics engine 810 senses the need of broadcasting response message 501 to user/victim 900 then it make use of server broadcaster engine 806 and pass the recovery plan/message for further processing. Whenever any emergency message remains unattended for a specific time period, the broadcasting module forwards such emergency message to the next available emergency responder. The management and analytics engine of the server application software without implying any limitation, comprises management and recovery message analyzer module, management and analytics module and user interface module. The management and recovery message analyzer module analyzes the received message from broadcaster engine and then sends to the management and analytics module. The management and analytics module prepares recovery plan and emergency response message 501 for the victim. The artificial intelligence of this engine determines recovery actions needed to be taken and making recovery plans using contact and other details of user 900/emergency responder 911/friend/family members 904/anonymous responder 902. The management and analytics module also populates the emergency message 500 details and emergency response 501 to the user interface module.

The server transmitter engine 812 of the server application software 800 encrypts emergency messages and recovery plan received from broadcaster engine and management and analytics engine and transmits them to identified user or to the emergency responder 911.

The server database recorder and logger Engine 808 of the server application software 800 is common engine which is connected with all other engines to record, archive and retrieve information from database. The Server Database Recorder and logger engine 808 also enables logging and troubleshooting of the system.

The Server Watch Dog Engine 814 automatically monitors and displays the health status of all the engines of server application software 800.

The different engines of the server application software 800 as described above, may running as different services make the entire system robust and prevent the collapsing of system from a single point of failure.

All the engines of server application software 800 call the server database recorder and logger engine 808 to record all details of emergency messages into database. All engines send details of the emergency message to data recording bus for retention and backup. The data recording bus act as interface between all engines and server database recorder and logger engine. All the operational details of all the server engines get recorded into the database.

In the various embodiments, the central server/cloud 700 may comprise a computer program/server application software 800 running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”). The central server/cloud 700 may be configured to exchange information with a user 900, emergency responders, guest 908 using the Simple Mail Transfer Protocol (SMTP), Internet Message Access Protocol (IMAP), Post Office Protocol (POP), or other protocols well-known to those of skill in the art.

In some embodiments, the user 900 instructs its phone 200 to transmit emergency message 500 to the central server/cloud 700 through a web browser, graphical user interface (GUI) coupled to a DPD and/or the central server 700.

The network including the user 900 and law enforcement 911 may take many different forms. Non-limiting examples of forms for communication system include local area networks (LANs), wide area networks (WANs), wired telephone networks, wireless networks, satellite networks or any other network supporting data communication between respective entities.

A computer program product server application software 800 running on the central server/cloud 700 may notify law enforcement 911 of an emergency using an phone call, SMS, email or via other means known to those of skill in the art.

The smart phones 200 may take many forms. Non-limiting examples of smart phones 200 include personal computers, personal digital assistants (PDAs), cellular phones and smartphones. The smart phones 200 may comprise a pointing device, a keyboard, a microphone, a display unit, a memory, CPU/microprocessor/micro controller, a mass memory storage, a GUI/touch screen, a video camera, an input/output interface/ports, communication ports and a network interface.

The central server/cloud 700 may comprise a single processor or multiple processors and may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory is used typically to transfer data and instructions to CPU in a bi-directional manner. Memory, as discussed previously, may include any suitable computer-readable media, intended for data storage, such as those described above excluding any wired or wireless transmissions unless specifically noted. Mass memory storage may also be coupled bi-directionally to CPU and provides additional data storage capacity and may include any of the computer-readable media described above. Mass memory storage may be used to store programs, data and the like and is typically a secondary storage medium such as a hard disk. It will be appreciated that the information retained within mass memory storage, may, in appropriate cases, be incorporated in standard fashion as part of memory as virtual memory.

The smart phones 200 may be configured to access on-demand, server application software 800 installed on the central server/cloud 700 through a web browser/web application software.

The present invention portable phone with integrated personal protection and emergency notification functionality 100 provides prompt aid to the user/victim 900 with the help of integrated personal protection means 150 and emergency responders 911.

The present invention 100 provides a user's smart security and emergency aid system to enable a user/victim 900 to seek assistance of emergency responders 911 such as police, medical and other agencies/when he/she is victim or witness of crime or when in medical emergency or a victim or witness of natural calamities like fire, earthquake, floods, etc and also the help and assistance of friends, family members and other near by persons.

The system 100 comprises combination of Mobile software application 400, mobile communication device 200 with customized user configurable buttons/touch sensitive keys integrated with a personal protection means 150 (housing 300 or war head unit 350), central server/cloud 700 with computer software/server application software 800 installed on it and the mobile communication devices 200 of the law enforcement or other emergency responders 911. The invention provides a highly robust system with much reduced downtime and lesser response time between a user who is a “Security/help Seeker” and police/law enforcement/other agencies or persons who are “Security/help Provider. The system of the present invention is an easy to operate system that works from a user's owned mobile communication device such as a mobile phone, iPad, iPhone, smart watch etc. which is provided with at least one user configured customized buttons/touch sensitive keys which when selectively pressed/clicked by the user, signals immediately the nearest emergency responders using phone call, SMS, MMS, email or other data connection service over PSTN and/or internet, satellite, or by bluetooth/wifi or other radio technology. On receipt of emergency signal 500 from the user 900, emergency responders 911 take the necessary recovery action depending on the priority/severity of crime/emergency situation and provide security or necessary aid to the user who is a victim or witness of crime or is in emergency situation.

This system records the emergency events through a user's 900 mobile communication device 200 and relays them to a police station/emergency responders 911. The user's 900 smart security and emergency aid system of the present invention comprises a mobile communication device 200 which could be a mobile phone, iPad, iPhone, smart watch or any other device with capability to connect, send, receive a data signal over wire/wireless telecom network. The mobile communication device 200 has, in some embodiments, a rear facing camera, dual cameras having a front facing camera in addition to the rear facing camera.

The server application software 800 installed on central server/cloud 700 comprises of several algorithms such as but not limited to the algorithm that always maintains IPs (Internet Protocol Addresses), email addresses and mobile numbers of at least three emergency responders 911 in proximity to location of the user/victim/witness of crime. When the user 900 activate the system by using the trigger/button/touch sensitive key configured with his mobile communication device 200, the emergency message/signal 500 thereby automatically generated and directed to the nearest emergency responders, pre-configured contact numbers of friends and family members and to the nearest anonymous responder calculated by the said algorithm. The interconnected mobile communication devices and computer's of police/emergency responder's, nearest anonymous responders, friends/family members thus create a secure zone. The emergency message 500 created upon activation of system by the trigger arrives at a mobile communication devices/computers of emergency responder's 911 via internet/data connection and/or via PSTN services such as but not limited to SMS, phone call, mms etc. This emergency message format may follow a protocol in various formats such as but not limited to XML, JSON or any other protocols or format well-known to those of skill in the art.

Various algorithms, methodologies and process are used for formulating, processing, wrapping and sending the emergency message 500 and emergency response message 501 between mobile communication devices/computers 200 of emergency responder's 911 and user/victim 900 securely.

The mobile software application 400 has the capability to work when there is low network signal strength. There may be situations such as when a user is located in a train, subway, tunnel, mining wells, etc. where network is available but the signal strength is weak for the mobile communication devices. Upon detecting such low signal of network and after the user 900 presses user configured buttons/touch sensitive keys/trigger, the mobile software application 400 will use SMS or other PSTN services in GSM mode or by using wifi/bluetooth or other data/signal transmission techniques on the phone to send the information to pre-configured contact numbers, nearest anonymous responder and to the mobile communication devices/computers of emergency responder's 911. The geographic location 502, media 504 forms part of the emergency message 500 received from the mobile software application 400 as above, and is processed by the server application software 800 installed on central server/cloud 700 using its various server engines and their algorithms without implying any limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A smart phone having integrated personal protection and emergency notification means, the smart phone comprising:
a housing partially enveloping the smart phone, the housing defining an internal recess for receiving a detachable pressurized canister of pepper spray, the housing comprising a physical button, a dispenser module, a interface module and a electromechanical means for activating the canister such that the pepper spray from the canister is emitted outward into ambient air when a user depresses physical button present on the housing or when a user depresses one or more pre-configured physical/virtual button of the smart phone;
a war head unit that can be either attached, clipped, affixed, slide upon, or latched onto a smart phone, the war head unit defining an internal recess for receiving a detachable pressurized canister of pepper spray, the war head unit comprising a physical button, a dispenser module, a interface module and a electromechanical means for activating the canister such that the pepper spray from the canister is emitted outward into ambient air when a user depresses physical button present on the war head unit or when a user depresses one or more pre-configured physical/virtual button of the smart phone.

2. The smart phone of claim 1, further comprising a computer/mobile software product in nontransitory computer-readable memory, for configuring physical button of the housing, for configuring physical/virtual button of the smart phone, and for displaying one or more virtual buttons on the smart phone, wherein activation of said physical/virtual controls:
dispenses pepper spray from the canister;
begins recordation of image, video and audio on the phone;
transmits an, emergency message comprising an alert siren, geographic location of the smart phone and recorded surrounding images, videos, audio, to a central server/cloud in logical communication with DPDs of a law enforcement agency or other emergency responders over a wide area network (WAN);

3. The smart phone of claim 0, wherein the canister is disposed in parallel orientation to a any side edge of the smart phone.

4. The smart phone of claim 0, wherein the canister is wholly enveloped by the housing such that a presence of the canister in the housing is imperceptible visually.

5. A computer/mobile software product of claim 2, further comprising of:
a configure and control module to configure the smart phone with the interface module and dispenser module of housing/war head unit;
to configure the smart phone physical/virtual controls and external devices to use as a triggers;
to control the dispenser module of housing/war head unit which further electronically activate the nozzle and dispense pepper spray in response to physical/virtual controls of the smart phone or external trigger being activated;
a client console module configured to display a list of message sent to law enforcement and a list of messages received from law enforcement, client console module also configured to take input from the user;
a client interpreter module configured to determine and interpret a physical/virtual controls/external trigger being activated by a user;
a client message formatter module configured to create, encrypt and decrypt messages sent/received to and from law enforcement; and
a transmitter receiver module configured to transmit an encrypted emergency message to law enforcement comprising alert siren, Geo-location of the phone and media recorded automatically on the smart phone in response to physical/virtual controls being activated. A transmitter receiver module is also configured to receive the emergency message in response from the law enforcement.

6. The smart phone of claim 1, wherein the smart phone can be any mobile communication device such as but not limited to smart phone, tablet, smart watch etc.

7. The housing/war head unit of claim 1 is connected with smart phone of claim 1 via USB/Bluetooth/wifi/RFID/Radio, Charging socket, earphone socket or plurality of such technology but not limited to or by any other port or socket or technology available in mobile communication device.

8. The smart phone of claim 1, is provided with at least one user configured customized physical/virtual controls which is selectable by a user in an emergency for the purposes of signaling to one or more emergency responders that a crime is in progress.

9. The client transmitter receiver module of claim 5, is also configured to transmit and receive emergency message using PSTN Infrastructure.

10. The housing/war head unit of claim 1, further comprising electromechanical means for activating the canister by opening the nozzle such that the pepper spray from the canister is emitted outward into ambient air.
